(19) United States
(12) Patent Application Publication
(10) Pub. No.: US 2026/0270577 A1
(43) Pub. Date: Sep. 10, 2026

(54) MULTIRESOLUTION/ MULTIDIMENSION EVENT SEARCH READOUT ARCHITECTURE FOR PIXEL DATA ACCESS IN EVENT BASED SENSORS

(71) Applicants: Hussein Ali, Foothill Ranch, CA (US); Mehdi Habibi, Lantana, TX (US); Rajkumar Chinnakonda Kubendran, Pittsburgh, PA (US)

(72) Inventors: Hussein Ali, Foothill Ranch, CA (US); Mehdi Habibi, Lantana, TX (US); Rajkumar Chinnakonda Kubendran, Pittsburgh, PA (US)

(21) Appl. No.: 19/440,562

(22) Filed: Jan. 5, 2026

Related U.S. Application Data
(60) Provisional application No. 63/769,711, filed on Mar. 10, 2025.

(51) Int. Cl. H04N 25/47; H04N 25/78

(52) U.S. Cl. CPC H04N 25/47; H04N 25/78

(57) ABSTRACT

Event-based sensors transfer data asynchronously, focusing on transmitting pixel data that undergo significant illumination changes, which reduces data transfer rates and power consumption compared to conventional frame-based imagers. The proposed architecture allows synchronous operation with the processor, eliminating the need for overhead coordination data, and introduces multiresolution techniques to reduce the number of access cycles required.

### RELATED APPLICATIONS

This application claims the priority of U.S. Provisional Application No. 63/769,711, entitled “MULTIRESOLUTION/MULTIDIMENTION EVENT SEARCH READOUT ARCHITECTURE FOR PIXEL DATA ACCESS IN EVENT BASED SENSORS” filed on Mar. 10, 2025, the disclosure of which is hereby incorporated by reference in its entirety.

### BACKGROUND OF THE INVENTION

Event based sensors are a generation of imagers optimized for high speed yet low data rate information transfers. With a lower data transfer rate, power consumption can be reduced to a considerable extent. Unlike conventional frame-based imagers which continuously transfer all the pixel data to the processor in a synchronous data link, a conventional event-based sensor would only transmit the status of pixels which have undergone significant illumination change. This would be performed in an asynchronous data link to allow the detection of an event with high timing accuracy. In this conventional event-based approach, the array is not continuously scanned by the processor, but rather the processor waits for an event to be generated by the pixel and when that happens it receives the information of the generated data.

Intuitively, with this approach it is expected that data transfer rate is reduced to a significant extent since when working with a static scene there are no pixels which sense a change and thus no data is transmitted to the receiving processor.

In practice, conventional event-based sensors face many limitations. An important drawback of the data transfer method in conventional event-based sensors is that since the data is generated asynchronously, the processor has no way of telling where an event signal has been originated from unless the event signal is augmented with the coordinates of the pixel which generated the event. At scenes with low dynamics this will not cause a major issue, however in reality even with low dynamic scenes, there are a lot of noisy events and thus the data overhead added to transfer a huge amount of noise events together with their coordinates will degrade the system performance. Another important limitation of conventional event-based sensors is the correct arbitration of events that happen at the same time and simultaneous registration of the generated data. When many events happen at the same time the bus transferring the information will be instantaneously overloaded and, in many cases, this will lead to loss of information.

Conventional event-based image sensors generate asynchronous signals whenever a significant illumination change is detected inside pixels. Due to the asynchronous nature of the events, the generated time stamp should also contain overhead coordination data to tell the receiver (processor) where the event corresponds to and, there exist difficulties in implementing conventional image processing algorithms on this data format.

### SUMMARY OF THE INVENTION

The embodiments discussed below include methods and architectures which give the event-based sensor the ability to operate synchronously with the receiver processor so that no overhead coordination information needs to the transmitted from the pixels. However, to avoid accessing the entire array by the processor, multiresolution and multidimension techniques are introduced which can significantly reduce the number of access cycles required by the processor to fetch the status of the event pixels.

In one embodiment, a readout architecture is presented which allows synchronous access to the event data. In the proposed method, the processor coordinates the event accesses and since the processor is aware of the time stamp and pixel coordinates it is accessing, unlike the asynchronous method, no overhead data needs to be sent together with the event status. To avoid full array access to identify pixels that have sensed significant pixel illumination change (event) a multiresolution (variable grain size) access method has been proposed in which pixel event status can be combined in groups of differently sized clusters. The processor seeks events starting from a coarse size cluster or equivalently low resolution and proceeds into finer and higher resolution settings. In an alternate approach, the 2D event data is mapped to a lower 1D dimension and based on the generated pattern, regions with high activity rate can be detected.

The proposed methods and architecture are designed to seek generated pixel change events in multiple phases using different grain sizes to facilitate synchronous processor coordinated event readout without the need for full array scans.

In one embodiment, event-based pixel sensors employ a multiresolution readout approach in which pixel events are accessed and read out, in groups of adjustable grain sizes. By changing the resolution (or equivalently grain size), the receiver (processor) can synchronously seek events inside the array and find pixels which have detected an illumination change without reading the event status of all pixels.

In one embodiment, event-based pixel sensors employ projection of the 2D spatially distributed events onto 1D x and y axis and subsequently by applying an activation function a stream of 1D bits is obtained at the periphery. The two 1D bit streams help the processor define the windows and regions where dense event activity has occurred.

The proposed configurable bit width row/column scanners can be used to select and acquire multiple rows/columns at a time and transfer the summed result of each cluster to the periphery. A threshold circuit acts as an activation function and produces an output if the number of pixels generating an event exceeds the threshold value. The processor seeks the event locations by addressing the row/column scanner while changing the grain size and threshold at each phase.

A method for readout in an event based sensor may include an algorithm or algorithms performing some or all of the following instructions. In one embodiment, the method may include arranging a plurality of event generating pixels in a scalable array. The scalable array includes a plurality of rows and a plurality of columns. The readout method may also include generating, by each of the plurality of event generating pixels, an event signal. An event signal may be indicative of an illumination change greater than an illumination threshold value. The event based sensor may set an event bit, associated with each of the plurality of event generating pixels, to an active state upon receiving the event signal. In one embodiment, the readout method may include specifying a region within the scalable array to perform readout access based on the event bit and reducing a number of pixel access operations performed by limiting scans of the scalable array to the specified region.

In some implementations, the event based sensor may perform scanning, by an adjustable output row scanner, the plurality of rows within the specified region of the scalable array. Similarly, the event based sensor may perform scanning, by an adjustable output column scanner, the plurality of columns within the specified region of the scalable array. The readout method may also modify a row grain size and a column grain size based on the event signal generated by the plurality of event generating pixels. In one embodiment, the row grain size and the column grain size may include adjusting a coarse grain size to a fine grain size. The event based sensor may be programmed to transmit a sum of event bits on a given column to an activation function block and compare, by the activation function block, an activation function threshold with the transmitted sum of event bits. The activation function block may be implemented as a sense amplifier and/or a differential sense amplifier.

The event based sensor may include programming instructions stored on a computer readable medium, which, when executed, perform the task of mapping a plurality of events triggered by exceeding an adaptive threshold by the plurality of event generating pixels and receiving, by a periphery processor, the mapped plurality of events triggered by exceeding the adaptive threshold. The periphery processor may extract a plurality of event window features.

A system for readout in an event based sensor may include a number of structural elements in hardware and/or logic circuits. Some of those system elements include a scalable array of event generating pixels. As noted above, the scalable array includes a plurality of rows and a plurality of columns. The plurality of event generating pixels may generate an event signal indicative of an illumination change greater than an illumination threshold value. The event based sensor may further associate an event bit with each of the plurality of event generating pixels. In one embodiment, the readout system may specify a region for performing readout access within, the specified region based on an active state setting of the event bit.

The system may further include an adjustable output width row scanner, the adjustable output width row scanner including a row address and a row grain size and an adjustable output width column scanner, the adjustable output width column scanner including a column address and a column grain size. In one embodiment, the adjustable output width row scanner modifies the row grain size based on the event signal generated and the adjustable output width column scanner modifies the column grain size based on the event signal generated. The event based sensor may adjust the row grain size and the column grain size from a coarse grain size to a fine grain size.

The system may further include an activation block receiving a sum of event bits from a given column. The activation block is configured to compare an activation function threshold with the transmitted sum of event bits. The activation function block may be implemented as a sense amplifier and/or a differential sense amplifier.

In one embodiment, the system may include a periphery processor receiving a mapping of a plurality of events triggered by exceeding an adaptive threshold by the plurality of event generating pixels. The periphery processor may be configured to extract a plurality of event window features from the mapping of the plurality of events triggered by exceeding the adaptive threshold.

### BRIEF DESCRIPTION OF THE FIGURES

FIG. 1 illustrates one embodiment of a multiresolution event-based readout sequence.

FIG. 2 illustrates a block diagram of exemplary hardware for multiresolution event access.

FIG. 3 illustrates a block diagram with adjustable width row/column scanner generated patterns.

FIG. 4 illustrates a block diagram with embodiments for an activation function.

FIG. 5 illustrates a block diagram for a multidimensional event-based data access technique.

FIG. 6 illustrates a block diagram of exemplary hardware for multidimensional event access.

FIG. 7 illustrates a conceptional subblock-based tiling approach to scale up the disclosed multiresolution and multidimensional access methods.

FIG. 8 illustrates a schematic diagram of a vision sensor system according to one embodiment.

### DETAILED DESCRIPTION OF THE INVENTION

The present invention is described in the following examples, which are set forth to aid in the understanding of the invention, and should not be construed to limit in any way the scope of the invention as defined in the claims which follow thereafter.

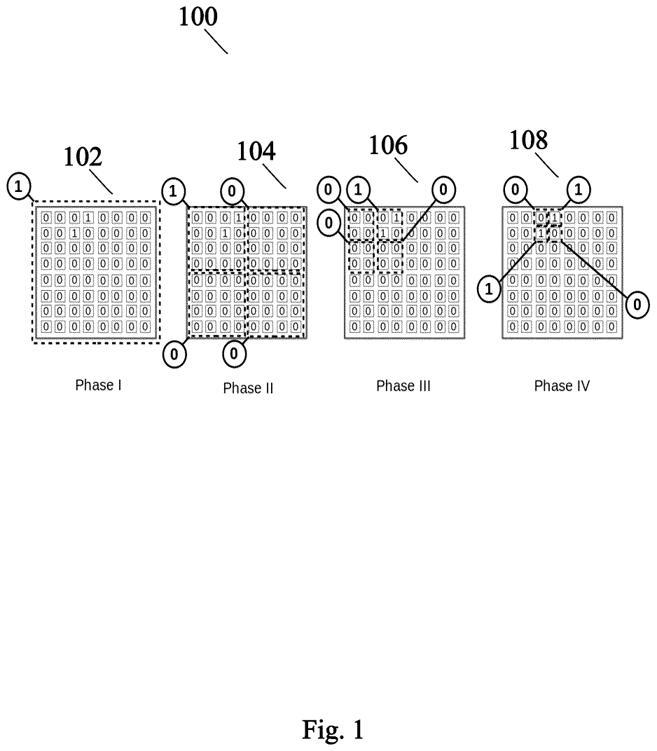

FIG. 1 illustrates one embodiment of a multiresolution event-based readout sequence 100. In the multiresolution approach presented in FIG. 1 the sensor plane is accessed at different cluster sizes. As can be seen in FIG. 1, the clustering sizes are represented by a dotted line surrounding all or a portion of the pixel array. In Phase I 102, the clustering size is 8×8. In Phase II 104, the clustering size is 4×4. Phase II illustrates four clusters at size of 4×4. Phase III 106 illustrates four clusters with a clustering size of 2×2. Finally, Phase IV 108 illustrates four clusters with a size of 1×1. A clustering function generates a single-bit result based on the event status of the cluster. A clustering function can be as simple as an OR operator which activates (if one of the pixels in the cluster is active) or “more than n” operator which activates if more than n pixels are activated or even involve logarithmic transforms. FIG. 1 shows the case of “two or more event” operator activation function for a conceptual 8×8 pixel array. For this set sample, the activation function of “more than 2” is applied at phases I, II and III and activation function of “more than one” is applied at phase IV. As the phases proceed the cluster size (resolution) gets finer.

Clusters with a zero-output activation function do not need to be divided into finer groups. Although there are many different possibilities but just as an example of how the general access can proceed, in the first phase the cluster can include all the pixels of the array. If no event exists, then the result of the activation function will be zero and further pixel accessing by the processor will not be necessary. If the activation function is positive, as is the case shown in the first phase of FIG. 1 and shown in the circle attached to the cluster, the cluster needs to be divided into finer regions, and the process commences in the subsequent phases with different clusters. While in conventional synchronous access, 8×8=64 access cycles are required to seek all the status of events and find the ones which have changed, in the disclosed method the activated events are found in 9 cycles.

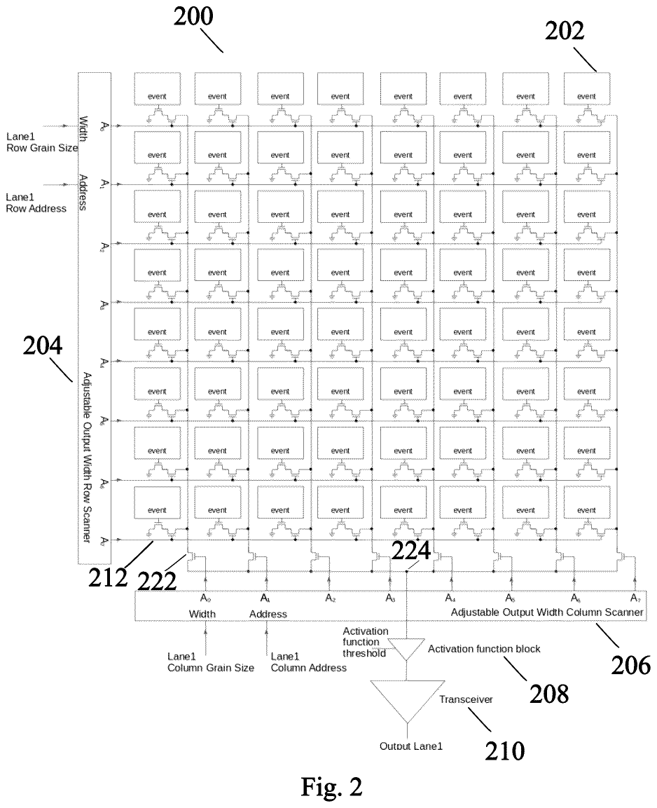

FIG. 2 illustrates a block diagram 200 of exemplary hardware for multiresolution event access. FIG. 2 illustrates an 8×8 array of event generating pixels 202 and their associated access transistor devices 212, an adjustable output width row scanner 204, orthogonal to the adjustable output width column scanner and an activation function block 208. The scanner can be scaled up for larger pixel arrays. The address determines the index of the group of output bits to be activated, and the Grain Size determines the size of the group. Larger group sizes have fewer possible address indexes. To access larger clusters of pixels the grain size must be set to a higher value. To perform accessing on a finer level the grain size setting needs to be set lower. As can be seen in FIG. 2, the adjustable output width row scanner includes a plurality of rows A₀-A₇. Similarly, the adjustable output width column scanner includes a plurality of columns A₀-A₇. Although an 8×8 pixel array is shown in FIG. 2, other size arrays may also be utilized in alternative embodiments, e.g., 240×180, 640×480, 1280×720. In communication with the column scanner is an activation function block 208 associated with an activation threshold which is transferred to a transceiver 210 with an output lane 1.

In one embodiment, the hardware includes a conceptual 8×8 pixel array. Each pixel generates a one-bit event signal and in most cases a polarity signal (not shown here) which is transferred to the output like the event signal. The event generating pixels sets the event bit to an active state if it has sensed an illumination change beyond its set threshold. The polarity bit determines the direction of change. If an event exists, the polarity must be accessed as well. Both the event signal and the polarity signal are single bit data lines. They can be generated by specialized pixel hardware.

For example, the specialized pixel hardware may include a closed loop logarithmic Transimpedance Amplifier (“TIA”) stage, a differential amplifier, a pair of 3 transistor comparators, and a logic which registers the generated event and sets a storage flip flop and an in-pixel access/processing circuitry. In the closed loop TIA, the load MOSFET on top of the photodiode logarithmically converts the photocurrent into a voltage signal while the feedback amplifier helps increase the bandwidth of the TIA.

The specialized pixel hardware may further include a gain stabilized amplifier which amplifies the weak signal and ensures consistent amplification regardless of variations in temperature or transistor behavior. Each comparator may be comprised of a combination of a common source (the nMOS and the upper pMOS) and common drain (the lower pMOS and the upper pMOS) amplifier. The upper pMOS acts as the load bias current for both the common source and common drain amplifiers. Whenever the gate voltage of the common source exceeds the voltage on the source of the nMOS plus the overdrive voltage, the output of the amplifier will be driven low and a change is initiated. The voltage to the common source is generated through the common drain stage. With high enough gain, this amplifier combination will function as a comparator.

With these comparators in mind, the maximum current of the comparator branch is controlled by the load pMOS current source and not dependent on the VUP and VDN threshold controlling voltages, still a good matching exists with the previous amplifier stage and thus the drifts of both stages can be cancelled out. After the comparators compare the signal against reference voltages VUP (Upper Threshold) and VDN (Lower Threshold), using a logic block, if either the comparator connected to VUP generates a high or the comparator connected to VDN generates a low an event is detected and the RS flipflop is latched on a set state. The state may be maintained until the scan_complete signal is asserted using out-of-pixel hardware A generated event signal may be connected to the in-pixel access/processing circuitry. In one embodiment, both access circuitry and processing have access to neighbor cells using either bus lines or local interconnects. These connections help the pixel communicate with the neighbors for data processing or to transfer the data to the output.

In the given example, the event states can be either accessed and read out synchronously by an external processor or used for asynchronous in-pixel processing. In both cases the scan_complete signal is generated synchronously among a group of pixels such as the entire array or row by row. Whenever an event is detected inside the pixel, using the in-pixel circuitry, the pixel is autonomously reset internally so that the pixel has enough time to reach steady state conditions. Whenever the generated events are read out by the acquiring processor or accessed through the in-pixel processing hardware, the pixel reset state is removed with the scan_complete signal synchronously. So, although the resetting is asynchronous but the removal of the pixel from the reset state is performed synchronously and thus the method is semi-autonomous.

The method disclosed here scans the pixel array and seeks/finds bits in which events have been generated. In prior art synchronous access methods, all the array bits must be scanned and accessed by a processor to discover the bits that have generated events in every ΔT time frame. In the proposed method, like other synchronous methods, scanning is performed in every ΔT time frame however a much smaller number of accesses are required to acquire the data if the event data generated is sparse. As with all other synchronous methods, after discovering the bits that have generated events at a specific time frame, an x and y coordinate and time stamp can be augmented to the extracted data using post processing stages which eventually just shape up how the final data is represented to the outside world. Nevertheless, with the given approach since the number of accesses is reduced considerably, further pixel event coordinates or timestamp augmenting can be omitted altogether and just the activation function block output can be delivered to the sensor's outputs. The threshold setting required to generate an event is supplied to the pixel itself.

For the conceptual pixel array of FIG. 2, only 1 output lane is considered. This can be configured based on the available output ports. Advantageously, the access approach disclosed here uses output-width adjustable row/column decoders. With the disclosed hardware, when an event is generated inside the pixel, the corresponding access transistor 212 which its gate is connected to the event signal can inject current into the common analog output bus 222. When multiple rows and columns are selected using the adjustable width row/column decoders, the current produced by the in-pixel transistor 212 of all pixels with an activated event is summed up at node 224. At the periphery the sum of the currents is converted to a voltage signal and compared with the applied threshold 207 in the Activation function block 208. If the number of events is higher than the applied threshold, the differential sense amplifier is activated. With this multiresolution method of assessing the results of clusters with variable sizes, if the events are sparse, the acquiring of the events can be achieved with a lower number of accesses and thus lower power consumption compared to the case where the event result of each pixel is accessed individually. This dedicated bit width adjustable decoder is an (Register-Transfer-Level) RTL logic designed to activate and scan multiple outputs at the same time.

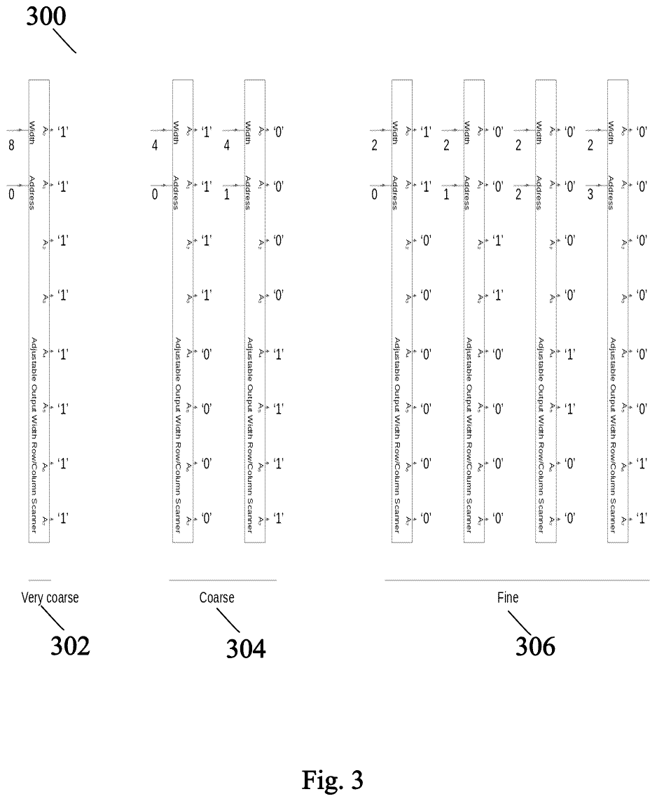

FIG. 3 illustrates a block diagram 300 with adjustable width row/column scanner generated patterns. As can be seen in FIG. 3, with the very coarse setting/phase 302 the row/column grain size is 8 and the row/column address is 0. Moving onto the coarse setting / phase 304, the row/column grain size is 4 and the row/column address is 0 in the first row/column and 1 in the second row/column. With respect to the fine setting/phase 306, the row/column grain size is 2 and the row/column address is 0, 1, 2 and 3 respectively as one moves from left to right. The grain sizes are adjusted by setting the programmable width of the row and column scanners. These values are determined based on the desired output data rate. As will be understood by those of skill in the art, a coarse and fine grain size may be based, at least in part, on the size of the array. Here, the 8×8 array has a coarse grain size of 8 and a fine grain size of 2. In an array that is 128×128, the coarse grain size may be 128, and the fine grain size may be 16 or less.

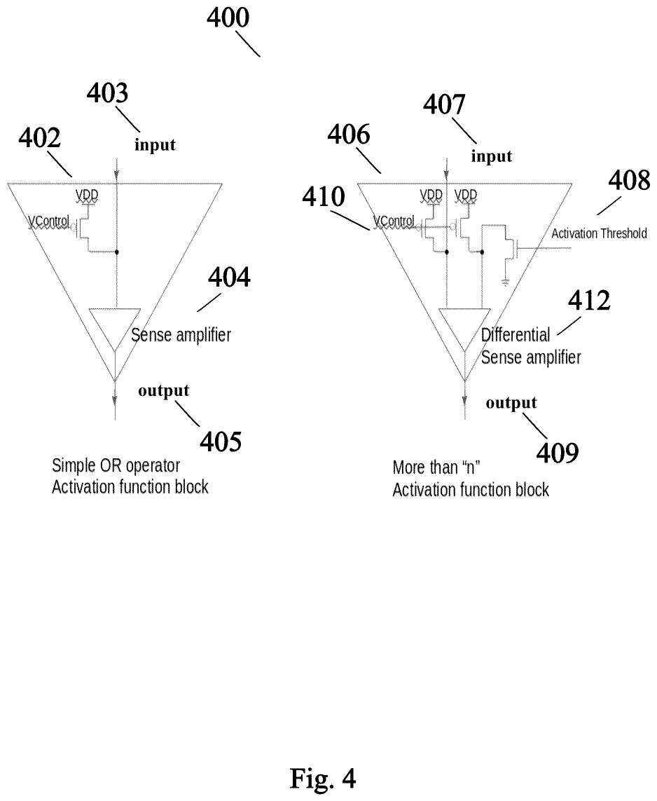

The activation block 208 shown in FIG. 2 has the function of producing a digital ‘1’ at the output when the number of activated pixels connected to the column bus exceeds a threshold value. For the simple case where this threshold is one, the activation function is simplified to an OR logic, and it is implementable with a simple pull-up. For higher activated pixels analog or mixed signal comparators. FIG. 4 illustrates a circuit diagram 400 with embodiments for an activation function. The circuit diagram 400 includes two circuits, a Simple OR circuit 402 and a “more than n” circuit 406. The Simple OR circuit includes a sense amplifier 404 which takes an analog input 403 to return a logical ON or 1 output 405. The “more than n” circuit 406 includes an activation threshold 408 and a differential sense amplifier 412. The differential sense amplifier 412 takes in two inputs, a control input 410 and an activation threshold input 408. The differential sense amplifier 412 may transmit an output signal 409 depending on the difference between the input 407 and the activation threshold input 408.

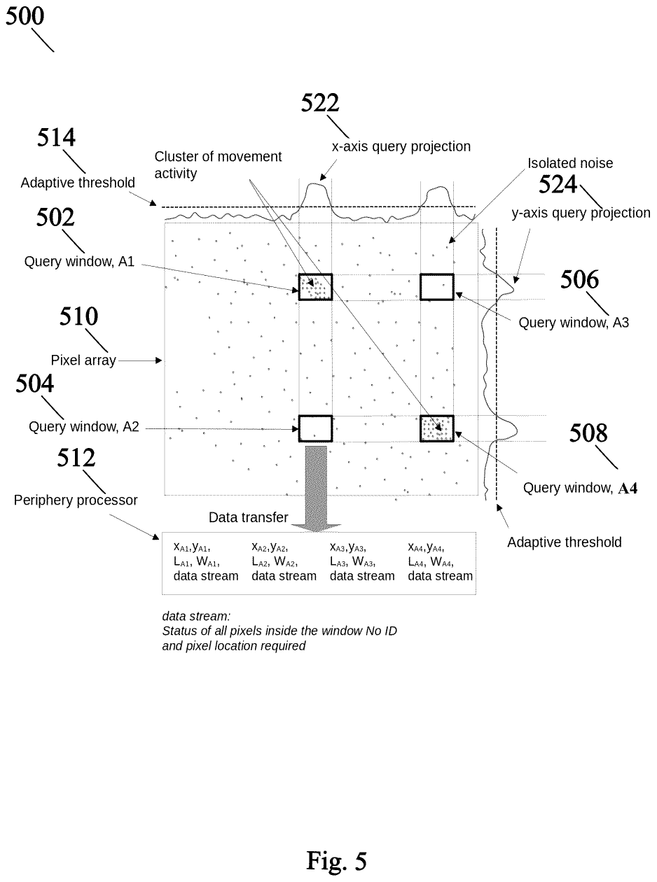

FIG. 5 illustrates a block diagram 500 for an event-based data multi-dimensional access technique. The block diagram 500 includes a pixel array 510 with a plurality of query windows A1 502, A2 504, A3 506 and A4 508. The block diagram also shows the adaptive threshold represented as a dotted line parallel to the x-axis query projection and y-axis projection. Values above the adaptive threshold line trigger an event. Additionally illustrated in FIG. 5 is the cluster of movement activity in query window A1 and query window A4.

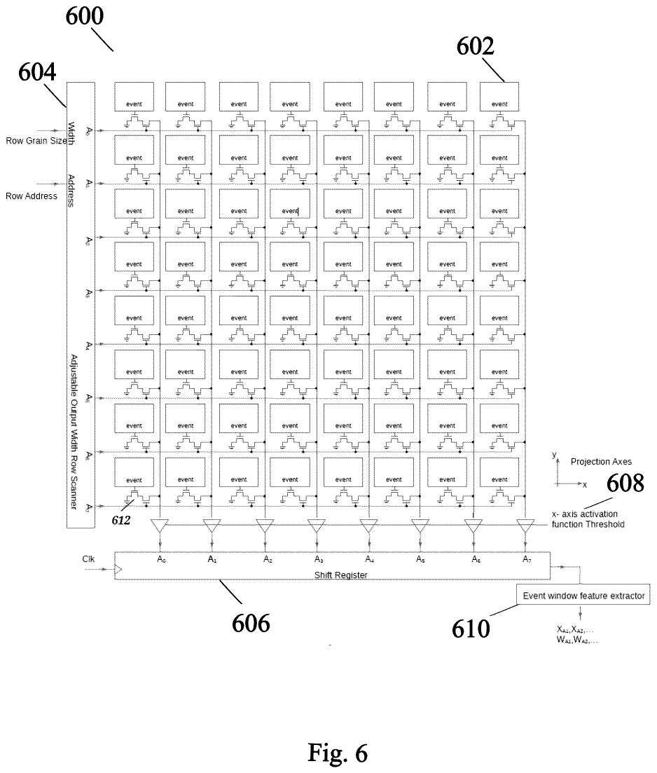

In the presented multidimension readout approach the events which are distributed spatially in the 2D array are mapped and fed to the activation functions at the periphery. This mapping is performed both on the 1D x-axis and 1D y-axis of the periphery. The periphery processor receives this mapped information and extracts event window features. X_{Ai}, Y _{Ai}, L _{Ai} and W _{Ai}, represent the x and y coordinates, together with length and width of the event window i respectively. The data stream consists of all the bits inside the event window without any coordination stamp as the position correspondence of the data stream bit can already be discovered using X_{Ai}, Y _{Ai}, L _{Ai}, W _{Ai} . With the disclosed multidimensional approach, since each event bit in the data stream does not need to be associated with a corresponding location and time stamp a much more efficient data transfer and power consumption can be obtained. The 1D projection patterns 522 and 524 generated at the x-axis and y-axis of the periphery are accessed and read by the periphery processor. As shown in FIG. 5, based on the 1D patterns the processor can then determine the windows which have high event activity and then access and read only these regions rather than the entire array. The hardware that can perform such a task is shown in FIG. 6.

FIG. 6 illustrates a block diagram 600 of exemplary hardware for multidimension event access. It comprises of an array of event generating pixels 602 and their associated access transistors 612, an adjustable output width row scanner 604, a polarity of x-axis activation function blocks 608, an x-axis event shift register 606 and an x-axis, event window feature extractor 610. Also not shown in the figure for the sake of simplicity, the disclosed hardware would include an adjustable output width column scanner, a polarity of y-axis activation function blocks, a y-axis event shift register, and a y-axis event window feature extractor. Thus, while the shown hardware projects the 2D pixel event data on the 1D x axis, another similar set of hardware is required to project the 2D data on the 1D y axis using a column scanner instead of a row scanner.

It should be noted that the illustration delivers the basic hardware required to extract X_{Ai} and W_{Ai}. The hardware block which projects the events on the y axis would extract Y_{Ai} and L_{Ai}. The block diagram illustrates an 8×8 pixel 602, an adjustable output width/row scanner 604, a shift-register 606, a plurality of activation function threshold blocks 608 located at Aᵢ-An, and an event window feature extractor 610. With the given approach the access transistors sum up the event on each column and deliver the result to the activation function block. If the number of events in a column exceeds a threshold, then a logic 1 may be registered at the periphery. The result of the activation function blocks is considered as the projection of the event region on the x axis and is transferred to the event window extraction block using the shift register to obtain X_{Ai} and W_{Ai}. Eventually using the event window features only the bits inside the event windows are accessed using separate in-pixel select and access transistor devices. While conventional bit by bit pixel scan and access methods can transfer all events to the output, that would require all pixels to be readout by the periphery. However, for scenarios where the event data is sparse, the disclosed approach can lead to lower number of bit transfers and thus lower power usage. Even for sparse events on the pixel array, conventional synchronous method would require reading all the pixel events bits individually by the periphery.

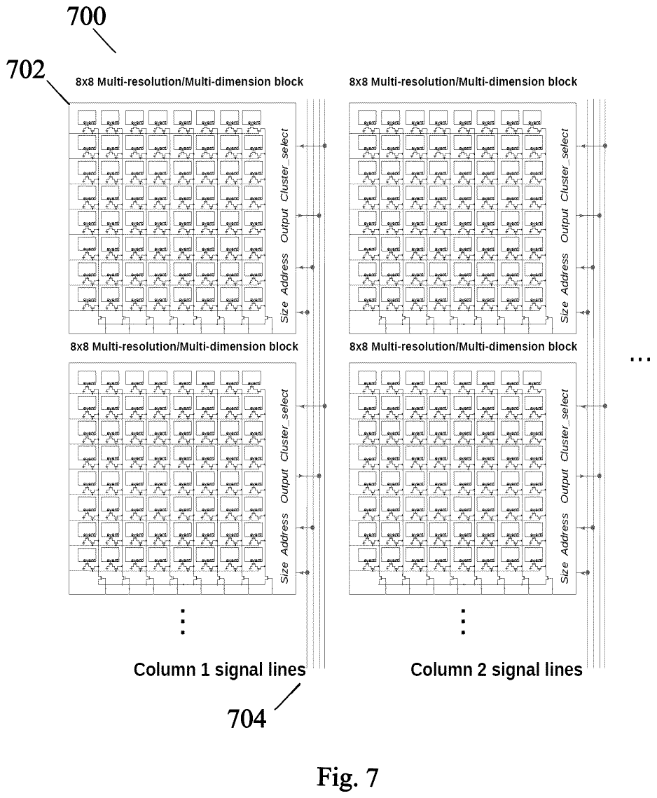

The suggested subblock-based tiling method is illustrated in FIG. 7 comprising a tile of either multiresolution or multidimensional event pixel blocks 702 and common column access signal lines 704. Although for actual implementation, the same architecture can be just scaled up, depending on the sensor final resolution, the average number of events present in the scene and other operational factors there could be scenarios in which a large pixel array is grouped into smaller tiles such as the depicted 8×8 embodiment and the outputs of the 8×8 tiles 702 are accessed one-by-one and sequentially using a common bus 704 routed to all the clusters.

The disclosed array access approach can be stacked on top of all digital type pixel arrays, significantly those which produce sparse bit information. As a specific case, the specialized pixel hardware described in connection with FIG. 2 can be used as the pixel blocks required to generate the event signals suitable for the disclosed access hardware.

As can be understood from above, Event-based vision systems depart fundamentally from conventional frame-based imaging by operating asynchronously and reporting only local changes in scene illumination. Instead of capturing full image frames at fixed time intervals, each pixel independently detects temporal contrast and emits an event when the change in intensity exceeds a defined threshold. Each event encodes pixel location, polarity, and precise timing, enabling continuous-time visual sensing with microsecond-level temporal resolution, extremely low latency, and reduced data redundancy.

This sensing paradigm is particularly advantageous in dynamic environments. Because information is generated only when change occurs, event-based sensors naturally suppress static background content and focus computational resources on relevant motion. The result is a significant reduction in bandwidth and power consumption compared to frame-based systems, while simultaneously increasing responsiveness and robustness to motion blur. The asynchronous nature of the output allows accurate perception under rapid motion, high dynamic range scenes, and low-light conditions where exposure-based imaging is limited.

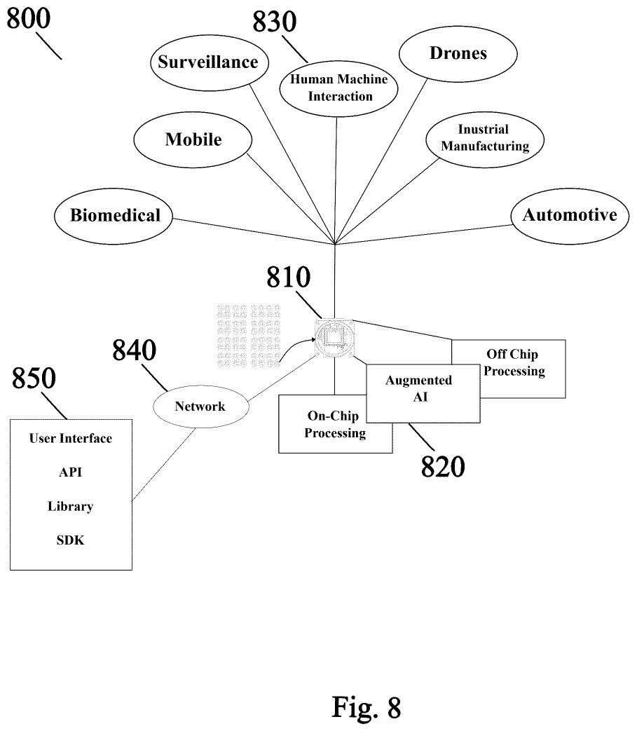

FIG. 8 illustrates a schematic diagram of a vision sensor system according to one embodiment. The vision sensor system 800 depicted in FIG. 8 includes a sensor/array of sensors 810, a suite of processing blocks 820, including on-chip processing, augmented AI and off chip processing. The schematic further includes a network 840 in communication with the sensor/array of sensors and a software stack 850. The software 850 may include a graphical user interface, an Application Programming Interface (API), a software library, and a software development kit (SDK). The software may include modules customized to operate in a set of environment specific applications 830. In one example, the et of environment specific applications may include biomedical, mobile, human machine interaction, industrial / manufacturing, drones and surveillance, among others.

In mobile and embedded imaging applications, event-based vision enables motion-aware reconstruction and stabilization. Continuous temporal sampling allows fine-grained estimation of motion vectors, which can be used to correct blur, track fast-moving features, or reconstruct intensity images with improved sharpness. These capabilities are especially valuable when either the sensor or the observed scene is in motion.

For human-machine interaction, event-driven sensing supports high-precision tracking of eye movements, gestures, and fine motor actions. Because temporal resolution is not constrained by a global frame rate, rapid micro-movements can be detected with minimal latency. This enables responsive interaction in immersive systems and allows detection of high-frequency visual phenomena such as flicker or subtle motion cues across a wide range of illumination levels.

In surveillance contexts, event-based vision enables detection of critical motion patterns—such as falls, intrusions, or abnormal activity—while inherently limiting the capture of identifiable visual detail. Since the sensor reports changes rather than full images, privacy-preserving observation is possible without sacrificing temporal fidelity or responsiveness. Similar advantages apply to crowd analysis, traffic monitoring, and visual odometry, where continuous motion estimation benefits from precise event timing and sparse data representation.

Industrial and manufacturing applications benefit from the ability of event-based sensors to observe motion over an extremely wide temporal bandwidth. The effective temporal resolution corresponds to frame rates on the order of hundreds of thousands to millions of frames per second, enabling analysis of vibrations, oscillations, and transient phenomena that are inaccessible to conventional cameras. This makes the technology well suited for high-speed object counting, particle tracking, conveyor monitoring, and predictive maintenance through vibration analysis.

In drones and robotic systems, event-based vision supports accurate tracking of edges, markers, and structural features in three dimensions. The high temporal precision improves pose estimation and motion prediction, which are critical for closed-loop control in manipulation, navigation, and pick-and-place automation. Continuous event streams allow robots to react to changes in real time rather than waiting for the next image frame.

For automotive and mobility systems, event-driven perception enhances object detection and tracking in challenging conditions, including high relative speeds, rapid lighting transitions, and scenes with extreme contrast. The sensors described herein also lend their advantages to autonomous driving tasks. Event-based sensing also supports real-time monitoring of driver behavior by detecting fine eye and facial movements, enabling rapid assessment of attention and alertness.

In biomedical and scientific applications, the ability to detect microscopic or subtle motion at high temporal resolution enables accelerated analysis of biological processes. Event-based sensors can identify motion signatures that occur on very short time scales, significantly reducing the duration of procedures that rely on visual observation of dynamic samples.

Across these application domains, the unifying technical advantage of event-based vision lies in its asynchronous, data-efficient representation of visual information. By encoding only meaningful temporal changes with precise timing, event-based systems provide high-speed, low-latency perception while minimizing power, bandwidth, and computational overhead compared to traditional frame-based imaging architectures.

The proposed access method is a suitable choice to be used in surveillance image sensors since in these applications usually there is very little activity unless a moving object is presented in front of the scene. Using the disclosed method the regions which experience high activity can be discovered and only pixels in those regions can be transferred to the output. This significantly reduces the number of accesses required in the array and reduces power consumption. For example, the 8×8 pixel sensor may be implemented within a dynamic vision sensor with a resolution of 128×128, a pixel pitch of around 40μm, a dynamic range of >120 dB (logarithmic pixel response), a latency of <15μs per event, power consumption of about 23 mW @30 million events, and an output under Address-Event Representation (AER) protocol.

While the foregoing invention has been described in some detail for purposes of clarity and understanding, it will be appreciated by one skilled in the art, from a reading of the disclosure, that various changes in form and detail can be made without departing from the true scope of the invention.

1. A method for readout in an event based sensor, comprising:
arranging a plurality of event generating pixels in a scalable array, the scalable array including a plurality of rows and a plurality of columns;
generating, by each of the plurality of event generating pixels, an event signal wherein the event signal is indicative of an illumination change greater than an illumination threshold value;
setting an event bit, associated with each of the plurality of event generating pixels, to an active state upon receiving the event signal;
specifying a region within the scalable array to perform readout access based on the event bit;
reducing a number of pixel access operations performed by limiting scans of the scalable array to the specified region.

2. The method for readout in an event based sensor of claim 1, further comprising:
scanning, by an adjustable output row scanner, the plurality of rows within the specified region of the scalable array.

3. The method for readout in an event based sensor of claim 1, further comprising:
scanning, by an adjustable output column scanner, the plurality of columns within the specified region of the scalable array.

4. The method for readout in an event based sensor of claim 1, further comprising:
modifying a row grain size and a column grain size based on the event signal generated by the plurality of event generating pixels.

5. The method for readout in an event based sensor of claim 4, wherein modifying the row grain size and the column grain size includes adjusting a coarse grain size to a fine grain size.

6. The method for readout in an event based sensor of claim 1, further comprising:
transmitting a sum of event bits on a given column to an activation function block;
comparing, by the activation function block, an activation function threshold with the transmitted sum of event bits.

7. The method for readout in an event based sensor of claim 6, wherein the activation function block includes a sense amplifier.

8. The method for readout in an event based sensor of claim 6, wherein the activation function block includes a differential sense amplifier.

9. The method for readout in an event based sensor of claim 1, further comprising:
mapping a plurality of events triggered by exceeding an adaptive threshold by the plurality of event generating pixels;
receiving, by a periphery processor, the mapped plurality of events triggered by exceeding the adaptive threshold.

10. The method for readout in an event based sensor of claim 9, further comprising:
extracting, by the periphery processor, a plurality of event window features.

11. A system for readout in an event based sensor, comprising:
a scalable array of event generating pixels, the scalable array including a plurality of rows and a plurality of columns;
an event signal generated by each of the plurality of event generating pixels, wherein the event signal is indicative of an illumination change greater than an illumination threshold value;
an event bit associated with each of the plurality of event generating pixels;
a region specified for performing readout access within, the specified region based on an active state setting of the event bit.

12. The system for readout in an event based sensor of claim 11, further comprising:
an adjustable output width row scanner, the adjustable output width row scanner including a row address and a row grain size.

13. The system for readout in an event based sensor of claim 12, further comprising:
an adjustable output width column scanner, the adjustable output width column scanner including a column address and a column grain size.

14. The system for readout in an event based sensor of claim 13, wherein the adjustable output width row scanner modifies the row grain size based on the event signal generated and the adjustable output width column scanner modifies the column grain size based on the event signal generated.

15. The system for readout in an event based sensor of claim 14, wherein the row grain size and the column grain size may be adjusted from a coarse grain size to a fine grain size.

16. The system for readout in an event based sensor of claim 11, further comprising:
an activation block receiving a sum of event bits from a given column, the activation block comparing an activation function threshold with the transmitted sum of event bits.

17. The system for readout in an event based sensor of claim 16, wherein the activation function block includes a sense amplifier.

18. The system for readout in an event based sensor of claim 16, wherein the activation function block includes a differential sense amplifier.

19. The system for readout in an event based sensor of claim 11, further comprising:
a periphery processor receiving a mapping of a plurality of events triggered by exceeding an adaptive threshold by the plurality of event generating pixels.

20. The system for readout in an event based sensor of claim 19, wherein the periphery processor extracts a plurality of event window features from the mapping of the plurality of events triggered by exceeding the adaptive threshold.
